(19) United States
(12) Patent Application Publication
(10) Pub. No.: US 2017/0338459 A1
(43) Pub. Date: Nov. 23, 2017

(54) SEPARATOR FOR A NON-AQUEOUS ELECTROLYTE BATTERY, NON-AQUEOUS ELECTROLYTE BATTERY, AND METHOD OF MANUFACTURING NON-AQUEOUS ELECTROLYTE BATTERY

(71) Applicant: TEIJIN LIMITED, Osaka-shi, Osaka (JP)

(72) Inventors: Takashi NAKAHIRO, Osaka-shi (JP); Susumu HONDA, Osaka-shi (JP)

(73) Assignee: TEIJIN LIMITED, Osaka-shi, Osaka (JP)

(21) Appl. No.: 15/535,514

(22) PCT Filed: Dec. 10, 2015
(86) PCT No.: PCT/JP2015/084719

§ 371 Date: Jun. 13, 2017

(30) Foreign Application Priority Data
Dec. 15, 2014 (JP) 2014-253109

(51) Int. Cl. H01M 2/16; C09J 127/16; C09J 127/20; H01M 10/0525

(52) U.S. Cl. CPC H01M 2/1686; H01M 2/166; H01M 10/0525; C09J 127/16; H01M 2/1653; C09J 127/20; H01M 2220/30

(57) ABSTRACT

In an embodiment of the present disclosure, provided is a separator for a non-aqueous electrolyte battery, the separator being composed of a composite membrane comprising: a porous substrate; and an adhesive porous layer provided on one side or both sides of the porous substrate and containing an adhesive resin, wherein the adhesive porous layer further contains an acrylic resin in a state in which the acrylic resin is mixed with the adhesive resin, a peel strength between the porous substrate and the adhesive porous layer is 0.20 N/10 mm or more, and a Gurley value is 200 sec/100 cc or less.

### TECHNICAL FIELD

The present disclosure relates to a separator for a non-aqueous electrolyte battery, a non-aqueous electrolyte battery, and a method of manufacturing a non-aqueous electrolyte battery.

### BACKGROUND ART

Non-aqueous electrolyte batteries typified by lithium ion secondary batteries are widespread as a power source for portable electronic devices such as notebook computers, mobile phones, digital cameras, and camcorders.

In recent years, with the miniaturization and weight reduction of portable electronic devices, the weight of outer packaging of non-aqueous electrolyte batteries has been reduced. An aluminum can has been developed as an outer packaging material in place of a stainless steel can, and a pack made of an aluminum laminate film has been developed in place of a metal can.

However, packs made of aluminum laminate film are softer than metal cans. Therefore, when the adhesive force between a coating layer constituting a separator and a substrate is weak, a battery using a pack as an outer packaging material (soft pack battery) has a problem that a coating layer is peeled from a base material due to impact from the outside or expansion and contraction of an electrode due to charging and discharging. As a result, there is a problem that a gap is formed between the electrode and the separator, and the cycle life of the battery is lowered

In order to solve the above-described problem, a technique for enhancing the adhesion between an electrode and a separator has been proposed. As one of such techniques, a separator is known in which an adhesive porous layer made of polyvinylidene fluoride resin (hereinafter also referred to as “PVDF layer”) is formed on a microporous polyolefin membrane (for example, see Japanese Patent No. 4127989).

However, since, in conventional PVDF layers, adhesion between a substrate and a PVDF layer has been insufficient, for example, when the separator is slit to a predetermined size, a phenomenon may occur in which a PVDF layer peels off from a substrate at a slit end face. There was a case where a PVDF layer was peeled off when a separator was rolled out or rolled up by a roll.

Conventionally, a technique has been developed for enhancing the adhesion of an adhesive porous layer to a substrate by using a polyvinylidene fluoride resin which is a copolymer of vinylidene fluoride/hexafluoropropylene (PVDF-HFP) (for example, see WO2014/136837, WO2014/136838).

Further, a technique is disclosed in which a viscous adhesive mixed with poly (methyl methacrylate) and polyvinylidene fluoride is applied to a porous polypropylene sheet used as a separator and the positive electrode and the negative electrode are closely adhered to each other before drying to obtain a battery layered body in a lithium ion secondary battery (see, for example, Japanese Patent No. 3997573).

### DISCLOSURE OF THE INVENTION

### Problem to be Solved by the Invention

As described above, a conventional separator having a PVDF layer has a handling problem as disclosed, for example, in Japanese Patent No. 4127989, and a technique capable of improving the handling property of a separator to improve the yield of battery manufacture has been desired.

From the viewpoint of further improving the load characteristics of a battery, it is desirable to further improve the ion permeability of a separator, and the techniques described in the above-described WO2014/136837 and WO2014/136838 have room for further improvement from this point of view.

It is desirable that an electrode and a separator have favorable peel strength between a positive electrode or a negative electrode and a separator.

As described above, in the past, there has not been proposed a technique for improving both handling properties and ion permeability in a separator having a porous substrate and an adhesive porous layer.

Accordingly, an object of the present disclosure is to provide a separator for a non-aqueous electrolyte battery in which both a handling property and an ion permeability are improved in a separator having a porous substrate and an adhesive porous layer. In the present disclosure, it is an object to provide a non-aqueous electrolyte battery having high manufacturing yield and excellent battery performance and a manufacturing method of the non-aqueous electrolyte battery.

### Means for Solving the Problem

Specific means for solving the above-described problems include the following aspects.
1. A separator for a non-aqueous electrolyte battery, the separator being composed of a composite membrane comprising: a porous substrate; and an adhesive porous layer provided on one side or both sides of the porous substrate and containing an adhesive resin, wherein the adhesive porous layer further contains an acrylic resin in a state in which the acrylic resin is mixed with the adhesive resin, a peel strength between the porous substrate and the adhesive porous layer is 0.20 N/10 mm or more, and a Gurley value is 200 sec/100 cc or less.
2. The separator for a non-aqueous electrolyte battery according to the item 1, wherein a content of the acrylic resin in the adhesive porous layer is from 5% by mass to 50% by mass based on a total mass of the adhesive resin and the acrylic resin.
3. The separator for a non-aqueous electrolyte battery according to the item 1 or 2, wherein the adhesive resin is a polyvinylidene fluoride resin.
4. The separator for a non-aqueous electrolyte battery according to any one of the items 1 to 3, wherein a crystallinity of the adhesive resin in the adhesive porous layer is from 10% to 55%.
5. The separator for a non-aqueous electrolyte battery according to any one of the items 1 to 4, wherein the adhesive porous layer further contains an inorganic filler, and a content of the inorganic filler in the adhesive porous layer is from 5% by mass to 75% by mass based on a total mass of the adhesive resin, the acrylic resin, and the inorganic filler.
6. The separator for a non-aqueous electrolyte battery according to any one of the items 1 to 5, wherein the acrylic resin is a copolymer containing a constitutional unit derived from at least one monomer of a carboxylate ester.
7. A non-aqueous electrolyte battery, comprising: a positive electrode; a negative electrode; and the separator for a non-aqueous electrolyte battery according to any one of the items 1 to 6 arranged between the positive electrode and the negative electrode, wherein electromotive force is obtained by doping/dedoping lithium.
8. A method of manufacturing the non-aqueous electrolyte battery according to the item 7, the method comprising: arranging the separator for a non-aqueous electrolyte battery between the positive electrode and the negative electrode to prepare a layered body (layering process); preparing an outer packaging body by placing the layered body and an electrolytic solution in an outer packaging material (outer packaging process); applying heat and pressure to the outer packaging body in a layering direction of the positive electrode, the separator for a non-aqueous electrolyte battery and the negative electrode in the layered body at a temperature of from 80° C. to 100° C. (heat pressing process); and sealing the outer packaging body (sealing process).

### Effect of the Invention

According to the present disclosure, there is provided a separator for a non-aqueous electrolyte battery having improved handling properties and ion permeability in a separator including a porous substrate and an adhesive porous layer.

According to the present disclosure, there is provided a non-aqueous electrolyte battery having high manufacturing yield and excellent battery performance, and manufacturing method of the battery.

### Best Mode for Carrying Out the Invention

Hereinafter, embodiments of the present invention will be described. Such descriptions and Examples exemplify the invention, and do not limit the scope of the invention.

Numerical ranges indicated by using “to” refer to ranges including values before and after “to” as the minimum value and the maximum value, respectively. With respect to a separator for a non-aqueous electrolyte battery according to embodiments of the invention, the term “width direction” means a direction orthogonal to the longitudinal direction of a separator manufactured in an elongated shape. The term “length direction” means a longitudinal direction (so-called machine direction) of a separator manufactured in an elongated shape. Hereinafter, “width direction” is also referred to as “TD direction”, and “length direction” is also referred to as “MD direction”.

<Separator for a Non-Aqueous Electrolyte Battery >

A separator for a non-aqueous electrolyte battery (hereinafter, also appropriately referred to “separator”) is composed of a composite membrane including a porous substrate and an adhesive porous layer provided on one side or both sides of the porous substrate and containing an adhesive resin, the adhesive porous layer further contains an acrylic resin in a state in which the acrylic resin is mixed with the adhesive resin, the peel strength between the porous substrate and the adhesive porous layer is 0.20 N/10 mm or more, and the Gurley value of the composite membrane is 200 sec/100 cc or less.

According to a separator of the present disclosure, a separator for a non-aqueous electrolyte battery in which both a handling property and an ion permeability are improved in a separator having a porous substrate and an adhesive porous layer can be provided. A non-aqueous electrolyte battery having high manufacturing yield and excellent battery performance and a manufacturing method of the non-aqueous electrolyte battery can be provided. Specifically, a separator for a non-aqueous electrolyte battery according to the present disclosure contains an adhesive resin and an acrylic resin in a state of being mixed with an adhesive porous layer, thereby controlling the crystallinity of the adhesive resin, and the adhesive force between an adhesive porous layer and a porous substrate can be increased and the permeability of the adhesive porous layer can be further improved. Since the peel strength between a porous substrate and an adhesive porous layer is 0.20 N/10 mm or more, peeling between a substrate and a coating layer is suppressed, and the handling property of a separator can be improved. Therefore, handling at the time of unwinding or winding of a roll becomes easier, so that the yield at the time of manufacturing a battery can be improved. By setting the Gurley value of the separator to 200 sec/100 cc or less, the load characteristics of the battery can be further improved.

In a non-aqueous electrolyte battery including such a separator, an electrode and the separator are adhered favorably, thereby improving cycle characteristics of the battery, and the non-aqueous electrolyte battery exhibits favorable charge/discharge performance.

Further, a separator according to an embodiment of the invention has a certain adhesive strength or more when an electrode and the separator are thermocompression bonded even at a stage before injecting an electrolytic solution, and therefore, the electrode and the separator are less likely to be displaced in a manufacturing process of a battery, and the process is easy to stabilize. There is also an advantage that static electricity charged on the surface of the separator is reduced and the handling property is improved even when the separator is thin, and as a result, the production yield of the battery can be improved.

[Porous Substrate]

In the invention, the term “porous substrate” means a substrate having pores or voids inside.

Examples of such a substrate include a microporous membrane; a porous sheet formed of a fibrous material, such as nonwoven fabric or a paper-like sheet; and a composite porous sheet obtained by layering one or more other porous layers on the microporous membrane or the porous sheet. The “microporous membrane” means a membrane that has a large number of micropores inside, and has a structure in which these micropores are joined, to allow gas or liquid to pass therethrough from one side to the other side.

The material used as a component of the porous substrate may be an organic material or an inorganic material as long as the material is an electrically insulating material.

The material used as a component of the porous substrate is preferably a thermoplastic resin from the viewpoint of imparting a shutdown function to the porous substrate. The term “shutdown function” refers to the following function. Namely, in a case in which the battery temperature increases, the thermoplastic resin melts and blocks the pores of the porous substrate, thereby blocking migration of ions, to prevent thermal runaway of the battery. As the thermoplastic resin, a thermoplastic resin having a melting point of less than 200° C. is suitable, and polyolefin is particularly preferred.

As the porous substrate using polyolefin, a microporous polyolefin membrane is suitable.

As the polyolefin microporous membrane, a polyolefin microporous membrane which has sufficient mechanical properties and ion permeability may be selected from polyolefin microporous membranes which have been applied to a conventional separator for a non-aqueous electrolyte battery.

From the viewpoint of exhibiting the shutdown function, the polyolefin microporous membrane preferably includes polyethylene, and the content of polyethylene is preferably 95% by mass or larger.

In addition, from the viewpoint of imparting heat resistance to such a degree that the membrane does not easily break when exposed to high temperatures, a polyolefin microporous membrane including polyethylene and polypropylene is suitable. An example of such a polyolefin microporous membrane is a microporous membrane in which polyethylene and polypropylene are present as a mixture in one layer. In such a microporous membrane, it is preferable that polyethylene is contained in an amount of 95% by mass or more and polypropylene is contained in an amount of 5% by mass or less, from the viewpoint of achieving both the shutdown function and heat resistance. From the viewpoint of achieving both the shutdown function and heat resistance, a polyolefin microporous membrane having a laminate structure of two or more layers, in which at least one layer includes polyethylene and at least one layer includes polypropylene, is also preferable.

It is preferable that the polyolefin contained in the polyolefin microporous membrane has a weight average molecular weight of from 100,000 to 5,000,000. When the weight average molecular weight is 100,000 or more, sufficient mechanical properties can be ensured. Meanwhile, when the weight average molecular weight is 5,000,000 or less, the shutdown characteristics are favorable, and it is easy to form a membrane.

The polyolefin microporous membrane can be manufactured, for example, by the following method. Namely, the polyolefin microporous membrane can be manufactured by a method of forming a microporous membrane by extruding a molten polyolefin resin through a T-die to form a sheet, subjecting the above sheet to a crystallization treatment, stretching the sheet, and further subjecting the sheet to a heat treatment. Alternatively, the polyolefin microporous membrane can be manufactured by a method of forming a microporous membrane by extruding a polyolefin resin melted together with a plasticizer such as liquid paraffin through a T-die, followed by cooling to form a sheet, stretching the sheet, extracting the plasticizer from the sheet, and subjecting the sheet to a heat treatment.

Examples of the porous sheet made of a fibrous substance include a porous sheet made of a fibrous material such as a polyester such as polyethylene terephthalate; a polyolefin such as polyethylene or polypropylene; or a heat resistant polymer such as aromatic polyamide, polyimide, polyether sulfone, polysulfone, polyether ketone, or polyether imide, or a porous sheet made of a mixture of the fibrous materials.

As the composite porous sheet, a structure in which a functional layer is layered on a porous sheet made of a microporous film or a fibrous material can be adopted. Such a composite porous sheet is preferable in that further functional addition can be performed by the functional layer. As the functional layer, for example, from the viewpoint of imparting heat resistance, a porous layer made of a heat-resistant resin or a porous layer made of a heat-resistant resin and an inorganic filler can be adopted. Examples of the heat-resistant resin include one or more heat-resistant polymers selected from aromatic polyamide, polyimide, polyethersulfone, polysulfone, polyetherketone and polyetherimide. As the inorganic filler, a metal oxide such as alumina, a metal hydroxide such as magnesium hydroxide, or the like can be suitably used. Examples of a method of compositing include a method of coating a functional layer on a microporous membrane or a porous sheet; a method of bonding a microporous membrane or a porous sheet and a functional layer with an adhesive; and a method of thermocompression bonding a microporous membrane or a porous sheet and a functional layer.

The thickness of a porous substrate is preferably in the range of from 5 μm to 25 μm from the viewpoint of obtaining favorable mechanical properties and internal resistance.

The Gurley value (JIS P 8117) of a porous substrate is preferably in the range of 50 sec/100 cc to 200 sec/100 cc from the viewpoint of preventing short circuit of a battery and obtaining sufficient ion permeability.

The puncture strength of a porous substrate is preferably 300 g or more from the viewpoint of improving the production yield.

[Adhesive Porous Layer]

An adhesive porous layer is provided on one side or both sides of a porous substrate, and is a porous layer which contains an acrylic resin and an adhesive resin in a mixed state. Such an adhesive porous layer has a large number of micropores inside, and has a structure in which these micropores are joined, to allow gas or liquid to pass therethrough from one side to the other side.

The state in which an acrylic resin and an adhesive resin are mixed means not a state in which particles of the acrylic resin and particles of the adhesive resin are merely mixed but a state in which the acrylic resin and the adhesive resin are mixed or compatibilized at the molecular level.

Since the acrylic resin and the adhesive resin are in a state of being mixed with each other, for example, the respective resins are compatible, the crystallinity of the adhesive resin is controlled, the adhesive force between the adhesive porous layer and the porous substrate is enhanced and the ion permeability of the adhesive porous layer is further improved. As a result, the peel strength between the porous substrate and the adhesive porous layer is increased to 0.20 N/10 mm or more, and peeling between a substrate and a layer is suppressed.

The adhesive porous layer is provided as an outermost layer of a separator on one side or both sides of a porous substrate and is a layer that can be bonded to an electrode when the separator and the electrode are stacked and heat pressed.

The adhesive porous layer is preferably on both sides rather than on only one side of the porous substrate from the viewpoint of excellent cycle characteristics (capacity retention rate) of a battery. This is because when an adhesive porous layer is on both surfaces of a porous substrate, both surfaces of a separator adhere well to both electrodes via the adhesive porous layer.

The adhesive porous layer can be formed by applying a coating liquid for forming an adhesive porous layer.

The coating amount of the coating liquid for forming an adhesive porous layer is preferably 1.0 g/m² to 3.0 g/m² as the total of both surfaces of the porous substrate. Here, the term “total of both surfaces of the porous substrate” with respect to the coating amount of the coating liquid for forming an adhesive porous layer means the coating amount on one side when the adhesive porous layer is provided on one side of the porous substrate, and the total coating amount on both sides when the adhesive porous layers are provided on both sides of the porous substrate.

When the coating amount is 1.0 g/m² or more, it is preferable from the viewpoint of favorable adhesion to an electrode and further improvement in cycle characteristics of a battery. On the other hand, when the coating amount is 3.0 g/m² or less, it is preferable from the viewpoint of favorable ion permeability and further improvement in load characteristics of a battery. More preferably, the coating amount of the adhesive porous layer is 1.5 g/m² to 2.5 g/m² as a total of both sides of the porous substrate. The coating amount of the adhesive porous layer is preferably from 0.5 g/m² to 1.5 g/m², and more preferably from 0.75 g/m² to 1.25 g/m² on one side of the porous substrate.

When the adhesive porous layer is provided on both surfaces of the porous substrate, the difference between the coating amount on one side and the coating amount on the other side is preferably 20% by mass or less with respect to the total coating amount on both sides. When the difference is 20% or less, a separator is hard to curl, and as a result, the handling property is further improved.

The thickness of the adhesive porous layer is preferably from 0.5 μm to 4μm on one side of the porous substrate. The thickness of 0.5 μm or more is preferably from the viewpoint of favorable adhesion to an electrode and improvement of the cycle characteristics of a battery. From such a viewpoint, the thickness of an adhesive porous layer is more preferably 1 μm or more on one side of the porous substrate. On the other hand, when the thickness is 4 μm or less, it is preferable from the viewpoint of favorable ion permeability and improved load characteristics of a battery. From such a viewpoint, the thickness of the adhesive porous layer is more preferably 3 μm or less, and even more preferably 2 μm or less, on one side of the porous substrate.

From the viewpoint of ion permeability, it is preferable that the adhesive porous layer has a sufficiently porous structure. Specifically, the porosity is preferably from 30% to 80%. When the porosity is 80% or less, it is preferable from the viewpoint of securing mechanical properties that can withstand a pressing process of bonding with an electrode. On the other hand, when the porosity is 30% or more, it is preferable from the viewpoint of improving the ion permeability.

The adhesive porous layer preferably has an average pore diameter of from 10 nm to 200 nm. When the average pore diameter is 200 nm or less, nonuniformity of pores is suppressed, adhesion points are uniformly scattered, and the adhesive property is further improved, which is preferable. When the average pore diameter is 200 nm or less, migration of ions is uniform, and cycle characteristics and load characteristics are further improved, which is preferable. On the other hand, when the average pore diameter is 10 nm or more, when the adhesive porous layer is impregnated with an electrolytic solution, a resin constituting the adhesive porous layer swells to block pores and it is difficult for the ion permeability to be inhibited.

(Adhesive Resin)

An adhesive resin contained in the adhesive porous layer is not particularly limited as long as the adhesive resin is capable of bonding to an electrode. For example, a polyvinylidene fluoride, a polyvinylidene fluoride copolymer, a styrene-butadiene copolymer, a homopolymer or copolymer of vinyl nitriles such as acrylonitrile or methacrylonitrile; and polyethers such as polyethylene oxide or polypropylene oxide are preferable.

The adhesive porous layer may contain only one adhesive resin or may contain two or more adhesive resins.

The adhesive resin contained in the adhesive porous layer is preferably a polyvinylidene fluoride resin from the viewpoint of adhesiveness to an electrode.

Examples of the polyvinylidene fluoride resins include homopolymer of vinylidene fluoride (or polyvinylidene fluoride), copolymer of vinylidene fluoride and another copolymerizable monomer (polyvinylidene fluoride copolymer), and a mixture thereof.

Examples of the copolymerizable monomer with the vinylidene fluoride include tetrafluoroethylene, hexafluoropropylene, trifluoroethylene, trichloroethylene, and vinyl fluoride, and one or two or more thereof can be used.

Polyvinylidene fluoride resins can be synthesized by emulsion polymerization or suspension polymerization.

Polyvinylidene fluoride resins preferably contain vinylidene fluoride as the constitutional unit in an amount of 98% by mole or more. When the constitutional unit derived from vinylidene fluoride is contained in an amount of 98% by mole or more, sufficient mechanical properties and heat resistance even for severe heat pressing conditions can be to be secured.

The weight-average molecular weight of a polyvinylidene fluoride resin is preferably in the range of from 300,000 to 3,000,000. When the weight-average molecular weight of the resin is 300,000 or more, an adhesive porous layer can secure mechanical properties that can withstand an adhesion treatment with an electrode, and sufficient adhesiveness can be easily obtained, which is preferable. From such a viewpoint, the weight average molecular weight of the polyvinylidene fluoride resin is more preferably 500,000 or more, and even more preferably 600,000 or more. On the other hand, when the weight average molecular weight is 3,000,000 or less, the viscosity at the time of molding does not become too high, the formability and crystal formation are favorable, and the porosity is favorable. From such a viewpoint, the weight average molecular weight of a polyvinylidene fluoride resin is preferably 2,000,000 or less, and more preferably 1,500,000 or less.

The fibril diameter of the adhesive resin is preferably in the range of from 10 nm to 1,000 nm from a viewpoint of cycle characteristics.

In the present disclosure, the crystallinity of the adhesive resin in the adhesive porous layer is preferably from 10% to 55%, and in particular, when the adhesive resin is a polyvinylidene fluoride resin, the crystallinity of the adhesive resin in the adhesive porous layer is particularly preferably from 10% to 55%.

When the crystallinity of the adhesive resin is 10% or more, the rigidity of the adhesive porous layer can be maintained, which is preferable from the viewpoint of high peel strength and high adhesion strength to the electrode. From such a viewpoint, the degree of crystallinity is more preferably 25% or more, and still more preferably 30% or more. On the other hand, when the crystallinity of the adhesive resin is 55% or less, a cell with low internal resistance can be produced by increasing the permeability of the adhesive porous layer, which is preferable from the viewpoint of improving battery performance. From such a viewpoint, the crystallinity is more preferably 45% or less.

(Acrylic Resin)

The acrylic resin is preferably composed of a homopolymer or a copolymer containing a constitutional unit derived from at least one type of carboxylic acid ester monomer.

The acrylic resin may be either a homopolymer of a carboxylate ester monomer or a copolymer of a carboxylate ester monomer and another monomer (for example, acrylic acid).

Specific example of the acrylic resin include an acrylic acid ester polymer obtained by polymerizing a monomer of carboxylic acid esters such as methyl acrylate, ethyl acrylate, isopropyl acrylate, n-butyl acrylate, 2-ethylhexyl acrylate, 2-hydroxyethyl acrylate, or hydroxypropyl acrylate; a methacrylic acid ester polymer obtained by polymerizing a monomer of a carboxylic acid ester such as methyl methacrylate, ethyl methacrylate, isopropyl methacrylate, butyl methacrylate, isobutyl methacrylate, n-hexyl methacrylate, cyclohexyl methacrylate, lauryl methacrylate, 2-hydroxyethyl methacrylate, hydroxypropyl methacrylate, or diethylaminoethyl methacrylate.

As another example of the acrylic resin include a copolymer obtained by copolymerizing a monomer of a carboxylic acid ester with another monomer such as acrylic acid, methacrylic acid, acrylamide, N-methylolacrylamide, or diacetone acrylamide.

Among the above, a homopolymer or a copolymer containing a constitutional unit derived from methyl methacrylate or methyl acrylate is preferable as the acrylic resin. As the acrylic resin, a copolymer at least containing a constitutional unit derived from methyl methacrylate or methyl acrylate and a constitutional unit derived from acrylic acid or methacrylic acid is preferable.

The content of the acrylic resin in the adhesive porous layer is preferably from 5% by mass to 50% by mass with respect to the total mass of the adhesive resin and the acrylic resin. When the content of the acrylic resin is 5% by mass or more, the peel strength between the porous substrate and the adhesive porous layer can be further increased, which is preferable. From such a viewpoint, the content of the acrylic resin is more preferably 7% by mass or more, further preferably 10% by mass or more, and particularly preferably 15% by mass or more. On the other hand, when the content of the acrylic resin is 50% by mass or less, brittleness of the adhesive porous layer hardly appears, cohesive failure in the layer hardly occurs, and excellent peel strength can be secured, which is preferable. From such a viewpoint, the content of the acrylic resin is more preferably 45% by mass or less, further preferably 40% by mass or less, and particularly preferably 35% by mass or less.

The weight average molecular weight of the acrylic resin is not particularly limited, and is preferably from 50,000 to 1,000,000. When the weight average molecular weight of the acrylic polymer is 50,000 or more, the film formability of the coating layer is improved and at the same time the strength and physical properties of the coating layer tend to be favorable. When the weight average molecular weight of the acrylic polymer is 1,000,000 or less, the optimum viscosity of a coating stock solution is given, and the productivity of a separator tends to be improved.

(Other Additives)

The adhesive porous layer may contain a filler or other components made of an inorganic material or an organic material.

By containing a filler, the slipping property and the heat resistance of a separator can be improved.

Examples of the inorganic filler include metal oxides such as alumina and metal hydroxides such as magnesium hydroxide. Examples of the organic filler include acrylic resins.

In cases in which the adhesive porous layer contains an inorganic filler, the content of an inorganic filler in an adhesive porous layer is preferably from 5% by mass to 75% by mass with respect to the total mass of an adhesive resin, an acrylic resin and an inorganic filler. When the content of the inorganic filler is 5% by mass or more, heat shrinkage of a separator at the time of heating can be suppressed and the size is stabilized, which is preferable. On the other hand, when the content of the inorganic filler is 75% by mass or less, cohesive failure in the inorganic filler layer hardly occurs and adhesion with an electrode is maintained at a certain level or more, which is preferable.

[Characteristics of Separator]

In a separator according to the present disclosure, it is important that the peel strength between a porous substrate and an adhesive porous layer is 0.20 N/10 mm or more.

When the peel strength is 0.20 N/10 mm or more, peeling between the porous substrate and the adhesive porous layer is suppressed, and the handling property of the separator can be improved. From such a viewpoint, the peel strength is more preferably 0.40 N/10 mm or more, and further preferably 0.60 N/10 mm or more. The upper limit value of the peel strength is not particularly limited, and is preferably 10 N/10 mm or less from the viewpoint of practical production.

The peel strength between the porous substrate and the adhesive porous layer is a value obtained by the method described in “Peel Strength between Porous Substrate and Adhesive Porous Layer” in Examples described below.

It is important that the Gurley value of the separator (composite membrane) is 200 sec/100 cc or less. When the Gurley value of the separator is 200 sec/100 cc or less, the ion permeability is good and the load characteristics of a battery can be further improved. From such a viewpoint, the Gurley value of the separator is more preferably 185 sec/100 c or less, and further preferably 165 sec/100 cc or less. The lower limit value of the Gurley value of the separator is not particularly limited, and is preferably 50 sec/100 cc or more from the viewpoint of realistic production.

The Gurley value is a value (sec/100 cc) measured using a Gurley Type Densometer (for example, G-B2C manufactured by Toyo Seiki Seisaku-sho, Ltd.) in accordance with JIS P 8117.

The above-mentioned peel strength and Gurley value can be controlled by mixing ratio of polyvinylidene fluoride resin and acrylic resin, molecular weight and crystallinity of polyvinylidene fluoride resin, manufacturing method (for example, the type or amount of a phase separation agent, the composition of a coagulation liquid), and the like.

In a separator for a non-aqueous electrolyte battery according to an embodiment of the invention, a difference between the Gurley value of a porous substrate and the Gurley value of a separator provided with an adhesive porous layer on the porous substrate is preferably 35 sec/100 cc or less, and more preferably 15 sec/100 cc or less from the viewpoint of ion permeability.

From the viewpoint of the mechanical strength and the energy density when formed into a battery, a separator for a non-aqueous electrolyte battery according to the embodiment of the invention preferably has a total film thickness of from 5 μm to 35 μm.

The porosity of a separator for a non-aqueous electrolyte battery according to the embodiment of the invention is preferably from 30% to 60% from the viewpoints of the mechanical strength, handling property and ion permeability.

[Manufacturing Method of Separator]

In the separator for a non-aqueous electrolyte battery according to the embodiment of the invention, is manufactured, for example, by a method in which a coating liquid containing a polyvinylidene fluoride resin and an acrylic resin is coated on a porous substrate to form a coating layer, and then the resin of the coating layer is solidified to thereby integrally form an adhesive porous layer on the porous substrate. Specifically, the adhesive porous layer containing polyvinylidene fluoride and acrylic resin can be formed, for example, by the following wet coating method.

A wet coating method is a film forming method in which (i) a process of preparing a coating liquid by dissolving a polyvinylidene fluoride resin and an acrylic resin in an appropriate solvent, (ii) a process of coating this coating liquid on a porous substrate, (iii) a process of solidifying the polyvinylidene fluoride resin and the acrylic resin while inducing phase separation by immersing the porous substrate in an appropriate coagulation liquid, (iv) a water washing process, and (v) a drying process are carried out to form an adhesive porous layer on a porous substrate. Details of the wet coating method suitable for the embodiment of the invention are as follows.

As a solvent (hereinafter also referred to as “good solvent”) for dissolving a polyvinylidene fluoride resin, an acrylic resin, and the like used for preparation of a coating liquid, a polar amide solvent such as N-methylpyrrolidone, dimethylacetamide, dimethylformamide, or dimethylformamide is suitably used.

From the viewpoint of forming a favorable porous structure, it is preferable to mix a phase separation agent which induces phase separation in addition to a good solvent. Examples of the phase separation agent include water, methanol, ethanol, propyl alcohol, butyl alcohol, butanediol, ethylene glycol, propylene glycol, and tripropylene glycol. The phase separation agent is preferably added within a range where a viscosity suitable for coating can be secured.

As the solvent, from the viewpoint of forming a good porous structure, a mixed solvent containing 60% by mass or more of a good solvent and 40% by mass or less of a phase separation agent is preferable.

From the viewpoint of forming a good porous structure, the concentration of a resin in the coating liquid is preferably from 1% by mass to 20% by mass with respect to the total mass of the coating liquid. When the adhesive porous layer contains a filler or other components, the filler and the other components may be mixed or dissolved in the coating liquid.

The coagulating liquid is generally composed of the good solvent and the phase separation agent used for preparing a coating liquid, and water. It is preferable from the standpoint of production to adjust the mixing ratio of the good solvent and the phase separation agent to the mixing ratio of a mixed solvent used for dissolving a resin. It is appropriate that the concentration of water is from 40% by mass to 90% by mass from the viewpoint of forming a porous structure and productivity.

When the coating liquid is coated on a porous substrate, conventional coating methods such as a Mayer bar, a die coater, a reverse roll coater, and a gravure coater may be applied. In the case of forming an adhesive porous layer on both surfaces of a porous substrate, it is preferable from the viewpoint of productivity to coat a coating liquid simultaneously on both surfaces of the substrate.

Besides the wet coating method described above, the adhesive porous layer can also be produced by a dry coating method. The dry coating method is a method in which, for example, a porous layer is obtained by applying a coating liquid containing a polyvinylidene fluoride resin, an acrylic resin and a solvent to a porous substrate and drying the coating layer to volatilize and remove the solvent. Since the coating layer tends to become dense as compared with a wet coating method in a dry coating method, the wet coating method is preferable from the viewpoint that the favorable porous structure can be obtained.

<Non-Aqueous Electrolyte Battery>

A non-aqueous electrolyte battery according to an embodiment of the invention is a non-aqueous electrolyte battery that obtains electromotive force by doping/dedoping lithium, and includes a positive electrode, a negative electrode, and a separator for a non-aqueous electrolyte battery according to an embodiment of the invention described above. The non-aqueous electrolyte battery has a structure in which a battery element in which a structure body in which a negative electrode and a positive electrode are opposed via a separator is impregnated with an electrolytic solution is enclosed in an outer packaging material.

The non-aqueous electrolyte battery according to an embodiment of the invention is suitable for a non-aqueous electrolyte secondary battery, particularly a lithium ion secondary battery.

Dope means occlusion, loading, adsorption, or insertion, which means a phenomenon in which lithium ions enter an active material of an electrode such as a positive electrode.

A non-aqueous electrolyte battery according to an embodiment of the invention is provided with a separator for a non-aqueous electrolyte battery according to the present disclosure described above as a separator, whereby an electrode and the separator are adhered well, the cycle characteristics of a battery are improved, and favorable charge/discharge performance is exhibited. Since the handling properties of a separator according to the present disclosure described above is excellent, it is possible to reduce the defective rate due to breakage of the separator, and as a result, the manufacturing yield of the battery can be improved.

The positive electrode may have a structure in which an active material layer including a positive electrode active material and a binder resin is formed on a current collector. The active material layer may further include an electrically conductive additive.

Examples of the positive electrode active material include lithium-containing transition metal oxides, and specific examples thereof include LiCoO₂, LiNiO₂, LiMn_{1/2}Ni_{1/2}O₂, LiCo_{1/3}Mn_{1/3}Ni_{1/3}O₂, LiMn₂O₄, LiFePO₄, LiCo_{1/2}Ni_{1/2}O₂, and LiAl_{1/4}Ni_{3/4}O₂.

Examples of the binder resin include a polyvinylidene fluoride resin and a styrene-butadiene copolymer.

Examples of the electrically conductive additive include a carbon material such as acetylene black, Ketjen black, or graphite powder.

Examples of the current collector include aluminum foil, titanium foil, and stainless foil having a thickness of from 5 μm to 20 μm.

In the non-aqueous electrolyte battery according to an embodiment of the invention, when a separator has an adhesive porous layer containing a polyvinylidene fluoride resin and an adhesive porous layer is arranged on a positive electrode side, since the polyvinylidene fluoride resin is excellent in oxidation resistance, it is easy to apply a positive electrode active material such as LiMnLiMn_{1/2}Ni_{1/2}O₂ or LiCo_{1/3}Mn_{1/3}Ni_{1/3}O₂ which can operate with a high voltage of 4.2 V or more, which is advantageous.

The negative electrode may have a structure in which an active material layer containing a negative electrode active material and a binder resin is formed on a current collector. The active material layer may further contain an electrically conductive additive.

Examples of the negative electrode active material include materials capable of electrochemically occluding lithium, and specific examples thereof include a carbon material, silicon, tin, aluminum, and Wood's alloy.

Examples of the binder resin include polyvinylidene fluoride resins and styrene-butadiene copolymer.

Examples of the electrically conductive additive include carbon materials such as acetylene black, Ketjen black, or graphite powder.

Examples of the current collector include a copper foil, a nickel foil, and a stainless steel foil, each having a thickness of from 5 μm to 20 μm.

Instead of using the negative electrode described above, a metal lithium foil may be used as the negative electrode.

The electrolytic solution is a solution obtained by dissolving a lithium salt in a non-aqueous solvent.

Examples of the lithium salt include LiPF₆, LiBF₄, and LiClO₄.

Examples of the non-aqueous solvent include cyclic carbonates such as ethylene carbonate, propylene carbonate, fluoroethylene carbonate, or difluoroethylene carbonate; chain carbonates such as dimethyl carbonate, diethyl carbonate, ethyl methyl carbonate, or a fluorine substitution product thereof; cyclic esters such as γ-butyrolactone or γ-valerolactone; and the like. These non-aqueous solvents may be used singly or in mixture.

As the electrolytic solution, a solution which is obtained by mixing cyclic carbonate and chain carbonate at a mass ratio (cyclic carbonate/chain carbonate) of from 20/80 to 40/60, and dissolving a lithium salt in the resulting mixed solvent to give a concentration of from 0.5 M to 1.5 M is preferred.

Examples of the outer packaging material include a metal can and an aluminum laminate film pack.

Examples of the shape of a battery include a square type, a cylindrical type, and a coin type. The separator for a non-aqueous electrolyte battery according to an embodiment of the invention is suitable for any shape.

<Manufacturing Method of Non-aqueous Electrolyte Battery>

The above non-aqueous electrolyte battery according to the present disclosure can be obtained by the following production method. Specifically, the method of manufacturing a non-aqueous electrolyte battery according to an embodiment of the invention includes:

(i) arranging the separator for a non-aqueous electrolyte battery between the positive electrode and the negative electrode to prepare a layered body (layering process);
(ii) preparing an outer packaging body by placing the layered body and an electrolytic solution in an outer packaging material (outer packaging process);
(iii) applying heat and pressure to the outer packaging body in a layering direction of the positive electrode, the separator for a non-aqueous electrolyte battery and the negative electrode in the layered body at a temperature of from 80° C. to 100° C. (heat pressing process); and
(iv) sealing the outer packaging body (sealing process).

According to such a manufacturing method, a non-aqueous electrolyte battery having a structure in which a battery element in which a structure body in which a negative electrode and a positive electrode are opposed via a separator is impregnated with an electrolytic solution is enclosed in an outer packaging material is obtained.

[Layering Process]

A layering process is a process of preparing a layered body by arranging a separator between the positive electrode and the negative electrode.

This process may be a system of layering the positive electrode, the separator, and the negative electrode on one another, each by at least one layer, in this order (a so-called stack system) or may be a system in which the positive electrode, the separator, the negative electrode, and the separator are stacked together in the order mentioned and wound in the length direction. Since a separator according to the present disclosure can adhere well to an electrode even when heat pressed in a state where an electrolytic solution is not included, a layered body may be subjected to heat pressing in this layering process. In such a case, positional displacement between the separator and the electrode in the layered body is less likely to occur, which can contribute to an improvement in battery production yield. Conditions of the heat pressing at this stage can be the same as those of the heat pressing process described below.

[Outer Packaging Process]

The outer packaging process is a process of preparing an outer packaging body (a structure in which a layered body and an electrolytic solution are contained in an outer packaging material) by placing the layered body and the electrolytic solution in the outer packaging material.

In this process, a layered body may be inserted into an outer packaging material and then an electrolytic solution may be injected, an electrolytic solution may be injected into an outer packaging material and then a layered body may be inserted, or insertion of a layered body and injection of an electrolytic solution into an outer packaging material may be simultaneously carried out. A layered body impregnated with an electrolytic solution may be inserted into an outer packaging material.

In this process, it is preferable that the interior of the outer packaging body containing a layered body and an electrolytic solution is in a vacuum state.

As the electrolytic solution, the above-described electrolytic solution for the non-aqueous electrolyte battery according to the present disclosure is preferable.

Examples of the outer packaging material include metal cans made of stainless steel or aluminum, packs made of aluminum laminate film.

[Heat Pressing Process]

The heat pressing process is a process of applying heat and pressure the outer packaging body. The direction of heat pressing is set to the layering direction of a positive electrode, a separator and a negative electrode in a layered body, and the electrode and the separator are bonded by this process.

The temperature of the heat pressing is from 80° C. to 100° C. Within this temperature range, the adhesion between the electrode and the separator is favorable, and since the separator can moderately expand in the width direction, short circuit of the battery hardly occurs.

When the temperature of the heat pressing is lower than 80° C., the electrode and the separator may not be adequately bonded, or the separator may not expand in the width direction, which may cause a short circuit of a battery.

On the other hand, when the temperature of the heat pressing is higher than 100° C., wrinkles may be generated in the separator and a short circuit of a battery may occur.

The pressure of the heat pressing is not particularly limited, and is preferably from 0.5 kg to 40 kg as the load per 1 cm² of an electrode.

The time of the heat pressing is not particularly limited, and is preferably from 0.5 minutes to 60 minutes.

As a method of heat pressing, for example, a method of heating and pressurizing by being sandwiched between hot plates or a method of passing heat between a pair of opposing heat rollers and applying heat and pressure may be applied.

[Sealing Process]

The sealing process is a process of sealing the outer packaging body and sealing a layered body and an electrolytic solution in an outer packaging material.

As a sealing method, for example, a system of adhering an opening of an outer packaging material with an adhesive, or a system of thermocompression bonding an opening of an outer packaging material by applying heat and pressure may be applied.

The heat pressing process and the sealing process are not required to be independent processes, and a system in which an electrode and a separator are bonded by heat pressing and an opening of an outer packaging material is thermocompression bonded may be used.

A heat pressing process may be performed after the sealing process.

In the manufacturing method according to the present disclosure, it is a matter of course that a variety of members useful for batteries other than the electrode and the separator are mounted. A variety of members may be mounted in each process, may be mounted between the above processes, or may be mounted after all of the above-described processes.

### EXAMPLES

Hereinafter, the invention is described in further detail with reference to Examples. Materials, amount of use, proportion, procedure, or the like described below can be appropriately modified without deviating from the spirit of the invention. Therefore, the scope of the invention should not be construed to be limited by the following specific examples.

<Measurement Method>

The following measurement methods have been applied to Examples and Comparative Examples below.

### [Film Thickness]

The film thickness (μm) of a separator and a porous substrate was determined by measuring 20 points with a contact thickness gauge (LITEMATIC manufactured by Mitutoyo Corporation), and arithmetically averaging the measured values. A cylindrical measurement terminal having a diameter 5 mm was used, and was adjusted such that a load of 7 g was applied during measurement.

The thickness of the adhesive porous layer was determined by subtracting the film thickness of the porous substrate from the film thickness of the separator to obtain the total thickness of both sides and making half of the total thickness as one side thickness.

[Weight per Unit Area]

The weight per Unit Area (weight per 1 m²) was determined by cutting a sample into a 10 cm×10 cm piece, measuring the weight of the piece, and dividing the weight by the area.

[Coating Amount of Adhesive Porous Layer]

A separator was cut into 10 cm×10 cm, the mass was measured, and the mass was divided by the area to obtain the weight per Unit Area of the separator. A porous substrate used for preparing the separator was cut into 10 cm×10 cm, the mass was measured, and the weight was divided by the area to obtain the weight per Unit Area of the porous substrate. Then, the weight per Unit Area of the porous substrate was subtracted from the weight per Unit Area of the separator, whereby the coating amount of the adhesive porous layer was determined. When the adhesive porous layer was formed on both sides, the coating amount per one side was obtained by dividing the coating amount obtained as described above by 2.

[Porosity]

The porosity of a separator was calculated by the following Formula.

ε={1−Ws/(ds·t)}×100

Here, ε is the porosity (%), Ws is the weight per Unit Area (g/m²), ds is the true density (g/cm³), and t is the film thickness (μm).

The porosity ε (%) of a separator formed by layering a polyethylene porous substrate and a porous layer composed only of a polyvinylidene fluoride resin was calculated by the following Formula.

ε={1−(Wa/0.95+Wb/1.78)/t}×100

Here, Wa is the weight per Unit Area (g/m²) of the polyethylene porous substrate, Wb is the weight (g/m²) of the polyvinylidene fluoride resin, and t is the film thickness (μm) of the separator.

The porosity ε (%) was calculated using the following Formula for a separator in which a porous layer obtained by mixing a polyvinylidene fluoride resin and an acrylic resin was layered.

ε={1−[Wa/0.95+Wb/(1.78×(B/100)+1.19×(C/100))]/t}×100

Here, B is the content concentration (% by mass) of the polyvinylidene fluoride resin, and C is the content concentration (% by mass) of the acrylic resin.

[Gurley Value]

The Gurley value (sec/100 cc) was measured by using Gurley Type Densometer (G-B2C, manufactured by Toyo Seiki Seisaku-Sho, Ltd.) in accordance with JIS P8117.

[Peel Strength of Porous Substrate and Adhesive Porous Layer]

A coated sample specimen was cut out in a size of 7 cm in length in the longitudinal direction and 1.2 cm in length in the width direction, and a transparent double-sided tape (manufactured by 3M Japan Limited) was attached to the sample surface. Next, the peeling strength at which an adhesive porous layer and a porous substrate were separated using a tensile strength measuring device (Tensilon RTC-1210A, manufactured by ORIENTEC CORPORATION) was measured and then converted into a value (unit: N/10 mm) per length of 10 mm in width.

[Adhesive Strength with Electrode (with Electrolytic Solution)]

A positive electrode and a negative electrode prepared by the following method were joined via a separator, an electrolytic solution was injected, and this battery element was sealed in an aluminum laminate pack with a vacuum sealer to prepare a test cell. After pressing the test cell with a heat press machine, the cell was disassembled and the strength when peeling off the electrode and the separator at 180° was measured to evaluate the adhesive strength with the electrode in the electrolytic solution. The hot press was performed under the condition that a pressure of 1.0 MPa was applied to the joined electrode and the separator, the temperature was 100° C., and the time was 10 seconds.

[Adhesive Strength with Electrode (without Electrolytic Solution)]

A positive electrode and a negative electrode prepared by the following method were joined via a separator, and in a state in which an electrolytic solution was not injected, this battery element was sealed in an aluminum laminate pack with a vacuum sealer to prepare a test cell. After pressing the test cell with a heat press machine, the cell was disassembled and the strength when peeling off the electrode and the separator at 180° was measured to evaluate the adhesive strength. The heat pressing was performed under the condition that a pressure of 1.0 MPa was applied to the joined electrode and the separator, the temperature was 100° C., and the time was 10 seconds.

[Charge Amount]

The voltage value (kV) of the static electricity charged on the surface of a separator was measured using Lightmatic VL-50 manufactured by Mitutoyo Corporation, and three measured values were averaged to obtain the charge amount.

[Crystallinity of Polyvinylidene Fluoride Resin]

An adhesive porous layer peeled off from a separator was used as a specimen and sealed in an aluminum pan for measurement, and the crystallinity of a polyvinylidene fluoride resin was determined by DSC (differential scanning calorimeter). For the measurement, DSCQ-20 (manufactured by TA Instruments Japan Inc.) was used, the heat of fusion of the polyvinylidene fluoride resin present in the adhesive porous layer was determined from the area of the endothermic peak appearing when the temperature was raised from 30° C. to 200° C. at a rate of 10° C./min, and the crystallinity Xc (%) was calculated by the following Formula (1).

Xc={ΔH/ΔHm^{*}}×100 (1)

Heat of fusion of complete crystal of polyvinylidene fluoride resin: ΔHm^{*}=104.7 J/g

[Handling Properties]

A separator was conveyed under conditions (conveying speed: 40 m/min., unwinding tension: 0.3 N/cm, winding tension: 0.1 N/cm), and after conveying, a peel of an adhesive porous layer was visually observed. Evaluation in accordance with the following evaluation criteria was then performed. As a foreign matter generated by peeling fell off from the separator, a matter fell off from the separator during conveying, a matter trapped by the end face of a winding roll, and a matter observed on the surface of the roll were counted.

### <Evaluation Criteria>

A: No peeling
B: Foreign matters generated by peeling: from one to five per 1000 m²
C: Foreign matters generated by peeling: from more than five to 20 per 1000 m²
D: Foreign matters generated by peeling: more than 20 per 1000 m²

[Cycle Characteristics]

Charge/discharge was repeated for a battery manufactured as described below under the environment of 30° C. with a charging conditions (1C, 4.2 V, constant-current and constant-voltage charging) and discharging conditions (1C, 2.75 V, cutoff constant-current discharging). The value obtained by dividing the discharging capacity at the 300-th cycle by the initial capacity was defined as a capacity retention rate (%), and used as an index of cycle characteristics.

[Load Characteristics]

For a battery manufactured as described below, the discharge capacity at the time of discharging at 0.2 C under the environment of 25° C., the discharge capacity at the time of discharging at 2 C were measured, and the value (%) obtained by dividing the latter by the former was taken as load characteristics. Here, the charging conditions were constant current constant voltage charging of 0.2 C and 4.2 V for 8 hours, and the discharging condition was constant current discharge of 2.75 V cutoff.

### Example 1

### (Manufacturing of Separator)

Vinylidene fluoride-hexafluoropropylene copolymer (KF 9300 manufactured by Kureha Chemical Industry Co., Ltd.) was used as the polyvinylidene fluoride resin and a copolymer of methyl methacrylate and methacrylic acid (PMMA; manufactured by Mitsubishi Rayon Co., Ltd.—ACRYPET MD001) was used as the acrylic resin. The polyvinylidene fluoride resin and the acrylic resin were mixed at a mass ratio of 75/25 and dissolved in a mixed solvent containing dimethylacetamide and tripropylene glycol (dimethylacetamide/tripropylene glycol=80/20 mass ratio) so that the components of the polyvinylidene fluoride resin and the acrylic resin were 3.8% by mass to prepare a coating slurry.

This was applied to both sides of a microporous polyethylene membrane (porous substrate; TN 0901: manufactured by SK Corporation) having a thickness of 9 μm, a Gurley value of 150 sec/100 cc, and a porosity of 43% on an equal basis and solidified by dipping in a coagulation liquid (35° C.; water/dimethylacetamide/tripropylene glycol =62.5/30/7.5 mass ratio) including water, dimethylacetamide, and tripropylene glycol.

This was washed with water and dried to obtain a separator for a non-aqueous electrolyte battery (composite membrane) according to one embodiment of the invention in which an adhesive porous layer containing a mixture of a polyvinylidene fluoride resin and an acrylic resin in a compatible state is formed on both surfaces of a microporous polyethylene membrane.

(Preparation of Negative Electrode)

300 g of artificial graphite as a negative electrode active material, 7.5 g of a water-soluble dispersion including a modified form of a styrene-butadiene copolymer in an amount of 40% by mass as a binder, 3 g of carboxymethyl cellulose as a thickener, and a proper quantity of water were stirred using a double-arm mixer, thereby preparing a slurry for a negative electrode. This slurry for a negative electrode was coated on a copper foil having a thickness of 10 μm as a negative electrode current collector, and the resulting coated membrane was dried, followed by pressing, to prepare a negative electrode having a negative electrode active material layer.

(Preparation of Positive Electrode)

89.5 g of lithium cobalt oxide powder as a positive electrode active material, 4.5 g of acetylene black as an electrically conductive additive, and 6 g of polyvinylidene fluoride as a binder were dissolved in N-methyl-pyrrolidone (NMP) such that the content of the polyvinylidene fluoride was 6% by mass, and the obtained solution was stirred using a double-arm mixer, thereby preparing a slurry for a positive electrode. This slurry for a positive electrode was coated on an aluminum foil having a thickness of 20 μm as a positive electrode current collector, and the resulting coated membrane was dried, followed by pressing, to produce a positive electrode having a positive electrode active material layer.

(Preparation of Battery)

A lead tab was welded to the positive electrode and the negative electrode, and the positive electrode, the separator, and the negative electrode were layered in this order to prepare a layered body. The layered body was inserted into a pack made of an aluminum laminate film and an electrolytic solution was further injected so that the layered body was impregnated with the electrolytic solution. As the electrolytic solution, 1 M LiPF₆-ethylene carbonate/ethyl methyl carbonate (mass ratio 3/7) was used.

Thereafter, the inside of the pack was evacuated using a vacuum sealer and temporarily sealed, a heat pressing was performed in the layering direction of the layered body together with the pack using a heat press machine, whereby adhesion between the electrode and the separator and sealing of the pack were performed. The conditions of heat pressing were a load of 20 kg per 1 cm² of the electrode, a temperature of 90° C., and a pressing time of 2 minutes.

### Examples 2 to 6

A separator for a non-aqueous electrolyte battery was obtained in the same manner as in Example 1 except that the content ratio (mass ratio) of the polyvinylidene fluoride resin and the acrylic resin in Example 1 was changed as listed in Table 1.

### Example 7

A separator for a non-aqueous electrolyte battery was prepared in the same manner as in Example 1 except that the acrylic resin in Example 1 was changed to polyethyl methacrylate (PEMA; PEMA manufactured by Aldrich Corporation).

### Example 8

A separator for a non-aqueous electrolyte battery was prepared in the same manner as in Example 1 except that the acrylic resin in Example 1 was changed to polybutyl methacrylate (PBMA; PBMA manufactured by Aldrich Corporation).

### Example 9

A separator for a non-aqueous electrolyte battery was prepared in the same manner as in Example 1 except that The content ratio (mass ratio) of the polyvinylidene fluoride resin and the acrylic resin was changed as listed in Table 1, and magnesium hydroxide having an average particle size of 0.8 μm and a BET specific surface area of 6.8 m²/g (Kisuma 5 P manufactured by Kyowa Chemical Industry Co., Ltd.) was added so that the mass ratio of magnesium hydroxide to a polyvinylidene fluoride resin and an acrylic resin was 40:60 in Example 1.

### Comparative Example 1

A separator for a non-aqueous electrolyte battery was prepared in the same manner as in Example 1 except that a vinylidene fluoride-hexafluoropropylene copolymer (KF 9300 manufactured by Kureha Chemical Co., Ltd.) which is a polyvinylidene fluoride resin is used, and an acrylic resin is not contained.

### Comparative Examples 2, 3

A separator for a non-aqueous electrolyte battery was obtained in the same manner as in Example 1 except that the content ratio (mass ratio) of the polyvinylidene fluoride resin and the acrylic resin in Example 1 was changed as listed in Table 1 It was.

### Comparative Example 4

A separator for a non-aqueous electrolyte battery was prepared in the same manner as in Example 9 except that a vinylidene fluoride-hexafluoropropylene copolymer (KF 9300 manufactured by Kureha Chemical Co., Ltd.) which is a polyvinylidene fluoride resin is used, and an acrylic resin is not contained.

### Evaluation

For the separators of Examples and Comparative Examples, the film thickness, the porosity, the Gurley value, the peel strength of the substrate and the adhesive porous layer, the adhesive strength to the electrode, the charge amount, the crystallinity of the polyvinylidene fluoride resin, and the handling properties were evaluated. For batteries using each separator, cycle characteristics and load characteristics were evaluated. The results are listed in Table 1. The coating amount and coating thickness of the adhesive porous layer listed in Table 1 are the coated amount per side and the coated thickness per finished surface.

TABLE 1

| | | | | Example | Example | Example | Example | Example | Example | Example |
|---|---|---|---|---|---|---|---|---|---|---|
| | | | | 1 | 2 | 3 | 4 | 5 | 6 | 7 |
| Adhesive | Content of adhesive resin | | mass % | 75 | 95 | 90 | 85 | 65 | 50 | 75 |
| porous layer | Content of acrylic | PMMA | mass % | 25 | 5 | 10 | 15 | 35 | 50 | — |
| | resin | PEMA | mass % | — | — | — | — | — | — | 25 |
| | | PBMA | mass % | — | — | — | — | — | — | — |

| | | | | | | | | | |
|---|---|---|---|---|---|---|---|---|---|
| | Content of inorganic filler | mass % | — | — | — | — | — | — | — |
| | Coated amount (one side) | g/m² | 1.0 | 1.0 | 1.0 | 1.0 | 1.0 | 1.0 | 1.0 |
| | Coated thickness (one side) | μm | 1.5 | 1.5 | 1.5 | 1.5 | 1.5 | 1.5 | 1.5 |
| properties of | Film thickness | μm | 12 | 12 | 12 | 12 | 12 | 12 | 12 |
| separator | Gurley value | sec/100 cc | 181 | 199 | 191 | 186 | 171 | 162 | 182 |
| | Porosity | % | 55 | 65 | 59 | 57 | 51 | 46 | 56 |
| | Peel strength | N/10 mm | 0.81 | 0.21 | 0.31 | 0.41 | 0.51 | 0.41 | 0.76 |
| | Adhesive Strength with | N/15 mm | 0.100 | 0.050 | 0.080 | 0.080 | 0.125 | 0.150 | 0.100 |
| | Electrode (with Electrolytic | | | | | | | | |
| | Solution) | | | | | | | | |
| | Adhesive Strength with | N/15 mm | 0.140 | 0.050 | 0.060 | 0.070 | 0.170 | 0.200 | 0.150 |
| | Electrode (without | | | | | | | | |
| | Electrolytic Solution) | | | | | | | | |
| | Charge amount | kV | 1.70 | 1.96 | 1.89 | 1.81 | 1.62 | 1.39 | 1.75 |
| | Crystallinity of adhesive | % | 31 | 55 | 46 | 41 | 26 | 11 | 31 |
| | resin | | | | | | | | |
| | Handling properties | — | A | B | B | A | A | A | A |
| Evaluation | Cycle characteristics | % | 97 | 95 | 95 | 96 | 98 | 97 | 98 |
| of battery | Load characteristics | % | 94 | 91 | 92 | 93 | 94 | 95 | 94 |

| | | | | | | Com- | Com- | Com- | Com- |
|---|---|---|---|---|---|---|---|---|---|
| | | | | Example | Example | parative | parative | parative | parative |
| | | | | 8 | 9 | Example 1 | Example 2 | Example 3 | Example 4 |
| Adhesive | Content of adhesive resin | | mass % | 75 | 30 | 100 | 97.5 | 40 | 40 |
| porous layer | Content of acrylic | PMMA | mass % | — | 10 | — | 2.5 | 60 | — |
| | resin | PEMA | mass % | — | — | — | — | — | — |
| | | PBMA | mass % | 25 | — | — | — | — | — |

| | | | | | | | | |
|---|---|---|---|---|---|---|---|---|
| | Content of inorganic filler | mass % | — | 60 | — | — | — | 60 |
| | Coated amount (one side) | g/m² | 1.0 | 1.0 | 1.0 | 1.0 | 1.0 | 1.0 |
| | Coated thickness (one side) | μm | 1.5 | 1.5 | 1.5 | 1.5 | 1.5 | 1.5 |
| properties of | Film thickness | μm | 12 | 12 | 12 | 12 | 12 | 12 |
| separator | Gurley value | sec/100 cc | 183 | 160 | 205 | 220 | 160 | 180 |
| | Porosity | % | 57 | 65 | 62 | 61 | 40 | 60 |
| | Peel strength | N/10 mm | 0.77 | 0.30 | 0.15 | 0.15 | 0.10 | 0.05 |
| | Adhesive Strength with | N/15 mm | 0.100 | 0.050 | 0.020 | 0.030 | 0.150 | 0.020 |
| | Electrode (with Electrolytic | | | | | | | |
| | Solution) | | | | | | | |
| | Adhesive Strength with | N/15 mm | 0.140 | 0.070 | 0.005 | 0.005 | 0.200 | 0.002 |
| | Electrode (without | | | | | | | |
| | Electrolytic Solution) | | | | | | | |
| | Charge amount | kV | 1.65 | 0.85 | 2.00 | 2.00 | 1.32 | 1.10 |
| | Crystallinity of adhesive | % | 33 | 32 | 58 | 54 | 5 | 60 |
| | resin | | | | | | | |
| | Handling properties | — | A | B | C | C | C | D |
| Evaluation | Cycle characteristics | % | 97 | 98 | 94 | 94 | 96 | 95 |
| of battery | Load characteristics | % | 93 | 93 | 90 | 91 | 94 | 92 |

As listed in Table 1, in Examples the adhesive resin and the acrylic resin were contained in a mixed state, the peel strength and the Gurley value between the porous substrate and the adhesive porous layer satisfied a predetermined range. As a result, peeling was suppressed, the handling property was excellent, and the manufacturing yield was improved.

Regardless of the presence or absence of the electrolytic solution, the adhesion between the electrode and the electrode was favorable, and the ion permeability of the adhesive porous layer was also excellent. Therefore, the cycle characteristics and load characteristics were excellent.

In contrast, in Comparative Examples in which the peeling strength and the Gurley value do not satisfy predetermined ranges, the peeling strength between the porous substrate and the adhesive porous layer was low, and the handling properties were remarkably inferior. The adhesion between the electrode and the electrode was also insufficient.

In Comparative Examples 3 to 4, although the ion permeability was favorable, the peeling strength between the porous substrate and the adhesive porous layer remarkably decreased and the manufacturing yield was low.

The disclosure of Japanese Patent Application No. 2014-253109 is incorporated by reference herein in its entirety.

All publications, patent applications, and technical standards mentioned in this specification are herein incorporated by reference to the same extent as if such individual publication, patent application, or technical standard was specifically and individually indicated to be incorporated by reference.

1. A separator for a non-aqueous electrolyte battery, the separator being composed of a composite membrane comprising: a porous substrate;
and an adhesive porous layer provided on one side or both sides of the porous substrate and containing an adhesive resin, wherein:
the adhesive porous layer further contains an acrylic resin in a state in which the acrylic resin is mixed with the adhesive resin,
a peel strength between the porous substrate and the adhesive porous layer is 0.20 N/10 mm or more, and
a Gurley value is 200 sec/100 cc or less.

2. The separator for a non-aqueous electrolyte battery according to claim 1, wherein a content of the acrylic resin in the adhesive porous layer is from 5% by mass to 50% by mass based on a total mass of the adhesive resin and the acrylic resin.

3. The separator for a non-aqueous electrolyte battery according to claim 1, wherein the adhesive resin is a polyvinylidene fluoride resin.

4. The separator for a non-aqueous electrolyte battery according to claim 1, wherein a crystallinity of the adhesive resin in the adhesive porous layer is from 10% to 55%.

5. The separator for a non-aqueous electrolyte battery according to claim 1, wherein:
the adhesive porous layer further contains an inorganic filler, and
a content of the inorganic filler in the adhesive porous layer is from 5% by mass to 75% by mass based on a total mass of the adhesive resin, the acrylic resin, and the inorganic filler.

6. The separator for a non-aqueous electrolyte battery according to claim 1, wherein the acrylic resin is a copolymer containing a constitutional unit derived from at least one monomer of a carboxylate ester.

7. A non-aqueous electrolyte battery, comprising:
a positive electrode;
a negative electrode; and
the separator for a non-aqueous electrolyte battery according to claim 1 arranged between the positive electrode and the negative electrode, wherein electromotive force is obtained by doping/dedoping lithium.

8. A method of manufacturing the non-aqueous electrolyte battery according to claim 7, the method comprising:
arranging the separator for a non-aqueous electrolyte battery between the positive electrode and the negative electrode to prepare a layered body;
preparing an outer packaging body by placing the layered body and an electrolytic solution in an outer packaging material;
applying heat and pressure to the outer packaging body in a layering direction of the positive electrode, the separator for a non-aqueous electrolyte battery and the negative electrode in the layered body at a temperature of from 80° C. to 100° C.; and
sealing the outer packaging body.

9. The separator for a non-aqueous electrolyte battery according to claim 2, wherein the adhesive resin is a polyvinylidene fluoride resin.
